(19) United States
(12) Patent Application Publication
(10) Pub. No.: US 2007/0114935 A1
(43) Pub. Date: May 24, 2007

(54) Plasma display panel

(76) Inventors: Min Hur, Yongin-si (KR); Byoung Min Chun, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,723

(22) Filed: Nov. 21, 2006

(30) Foreign Application Priority Data
Nov. 22, 2005 (KR) 10-2005-0111909

(51) Int. Cl. H01J 17/49

(52) U.S. Cl. 313/586; 313/587

(57) ABSTRACT

Disclosed is a plasma display panel. The plasma display panel includes discharge cells having the delta structure, in which a center portion of a dielectric layer provided at each lateral side of the delta-type discharge cell has a width larger than that of a peripheral portion of the dielectric layer, thereby improving the luminous efficiency of the plasma display panel.

### CROSS-REFERENCE TO RELATED APPLICATION

This application claims priority to and the benefit of Korean Patent Application No. 10-2005-0111909 filed in the Korean Intellectual Property Office on Nov. 22, 2005, the entire content of which is incorporated herein by reference.

### BACKGROUND OF THE INVENTION

1. Field of the Invention

The present disclosure relates to a plasma display panel. More particularly, the present disclosure relate to a plasma display panel, in which a center portion of a dielectric layer provided at each lateral side of a delta-type discharge cell has a width larger than that of a peripheral portion of the dielectric layer, thereby improving the luminous efficiency of the plasma display panel.

2. Description of the Related Art

As generally known in the art, a plasma display panel refers to a panel used in a plasma display device, which is one of the currently available flat display devices. The plasma display panel displays an image using a visible ray, which is emitted from a phosphor layer when the phosphor layer is excited by means of an ultraviolet ray generated from plasma, which is generated when a gas discharge is performed with discharge gas being injected into a discharge space formed between two opposite substrates. Such a plasma display panel can be classified into a DC type plasma display panel, an AC type plasma display panel and an AC-DC type plasma display panel according to the structure and driving principle thereof. In addition, the plasma display panel can be classified into a surface discharge type plasma display panel and an opposed type plasma display panel according to the discharge structure thereof.

According to the surface discharge type plasma display panel, a distance between the scan electrode and the address electrode is relatively long, so that a relatively large discharge voltage is required. In addition, the discharge starts at an area in which a distance between two electrodes is narrowest (that is, the center area of a discharge cell). After that, the discharge is generated at a peripheral area of the electrodes. This is because the center area of the discharge cell requires a relatively low discharge voltage for the discharge operation. Once the discharge operation starts, space charges are generated so that the discharge operation can be maintained with a predetermined voltage lower than the initial discharge voltage and the voltage applied between two electrodes is gradually reduced. During the discharge operation, ions and electrons are accumulated in the center area of the discharge cell, so that intensity of an electric field in the center area of the discharge cell may become attenuated and the discharge in the center area of the discharge cell may vanish. That is, since the voltage applied between two electrodes becomes reduced as time goes by, a strong discharge may occur at the center area of the discharge cell having a low luminous efficiency and a weak discharge may occur at the peripheral area of the discharge cell having a high luminous efficiency. In this way, the three-electrode surface discharge type plasma display panel uses a relatively lower amount of input energy for heating electrons, so that the luminous efficiency of the plasma display panel may be degraded. In general, the plasma display panel includes a top substrate, a bottom substrate facing the top substrate, and discharge cells defined by barrier ribs. In addition, scan and address electrodes alternately extend along the discharge cells.

Recently, in order to solve the problem occurring in the three-electrode surface discharge type plasma display panel, an opposed discharge type plasma display panel has been developed. According to the opposed discharge type plasma display panel, sustain electrodes and scan electrodes are formed in intermediate barrier ribs in opposition to each other at a space formed between a top substrate and a bottom substrate, and address electrodes extend while crossing the sustain and scan electrodes. Therefore, according to the opposed discharge type plasma display panel, a distance between a scan electrode and an address electrode is shorter than a distance between the scan electrode and the address electrode of the surface discharge type plasma display panel, so that the address voltage is relatively lowered. In addition, according to the opposed discharge type plasma display panel, the plasma discharge is generated over the whole area of the discharge cell, so that a discharge space is enlarged, thereby improving the discharge efficiency.

Different from the discharge cells provided in the surface discharge type plasma display panel, the discharge cells provided in the opposed discharge type plasma display panel can be variously aligned. For instance, the discharge cells can be aligned in the matrix structure or the delta structure. According to the matrix structure, the discharge cells are uniformly distributed in one direction and the other direction and phosphor layers representing the same color is formed along one direction. Therefore, three discharge cells aligned in parallel to each other may form one pixel in the matrix structure. In contrast, according to the delta structure, three adjacent discharge cells formed with phosphor layers representing different colors are aligned in a triangular pattern so as to form one pixel.

In the opposed discharge type plasma display panel, when the same voltage is applied to the scan electrodes and the sustain electrodes, the voltage applied to the dielectric layer from an exterior increases proportionally to the thickness of the dielectric layer. Accordingly, as the thickness of the dielectric layer becomes enlarged, the voltage applied to a gap formed between the scan electrode and the sustain electrode may be reduced so that the current is also reduced. In general, if the voltage applied to the scan electrode and the sustain electrode increases, the current also increases. Meanwhile, as generally known in the art, if the current is reduced, the luminous efficiency is improved.

In addition, the scan electrode and the sustain electrode, which generate the sustain discharge in the plasma display panel, are formed on outer surfaces thereof with the dielectric layer having a uniform thickness, so that the scan electrode and the sustain electrode can be uniformly spaced apart from the internal space of the discharge cell. Therefore, when viewed from the internal space of the discharge cell, the scan electrode and the sustain electrode are formed in one side and the other side of the dielectric layer, respectively, but the electrodes are not formed in the middle portion of the dielectric layer. Accordingly, electrons generated in the vicinity of the middle portion of the dielectric layer during the discharge operation may collide with the middle portion of the dielectric layer, causing loss of electrons. In this case, a portion of the electrons used for generating the ultraviolet ray may be relatively reduced, so that the luminous efficiency of the plasma display panel may be degraded.

The plasma display panel may represent the higher luminous efficiency as the ultraviolet ray efficiency (that is, a proportion of energy used for generating the ultraviolet ray from among input energy resources) becomes high and visible ray loss becomes low. Here, the visible ray loss is determined depending on the proportion of the ultraviolet ray reaching the phosphor layer and the proportion of the visible ray reaching the top substrate. Thus, if the scan electrodes and the sustain electrodes are formed closer to the top substrate that that of the phosphor layer, the scan electrodes and the sustain electrodes may partially hide the phosphor layer formed on the bottom substrate, thereby interrupting the ultraviolet ray introduced into the phosphor layer and the visible ray introduced into the top substrate. That is, the opposed discharge type plasma display panel causes visible ray loss depending on the alignment of the scan electrodes and the sustain electrodes, thereby lowering the luminous efficiency thereof.

### SUMMARY OF THE INVENTION

Accordingly, the present disclosure has been made to solve one or more of the above-mentioned problems, and an object of the claimed disclosure is to provide a plasma display panel, in which a center portion of a dielectric layer provided at each lateral side of a delta-type discharge cell has a width larger than that of a peripheral portion of the dielectric layer, thereby improving the luminous efficiency of the plasma display panel.

In order to accomplish the above object, the present embodiments provide a plasma display panel comprising: a top substrate and a bottom substrate aligned in opposition to the top substrate; a plurality of address electrodes aligned in parallel to each other while extending in one direction between the top substrate and the bottom substrate; first and second electrodes extending in a direction crossing the address electrodes and alternately aligned in parallel to each other; barrier ribs including first barrier ribs aligned in parallel to the first and second electrodes, and second barrier ribs aligned in a direction crossing the first barrier ribs in such a manner that discharge cells defined by the first and second barrier ribs are aligned at both sides of the first barrier ribs while being offset from each other about the first barrier ribs; dielectric layers including first dielectric layers formed on outer surfaces of the first and second electrodes, second dielectric layers formed on upper surfaces of the second barrier ribs such that the second dielectric layers cross the first dielectric layers, and inner dielectric layers protruding toward inner portions of the discharge cells from intersection regions between the first and second dielectric layers; and phosphor layers formed on an upper surface of the bottom substrate and on lateral sides of the barrier ribs in the discharge cells. The address electrodes are formed on a lower surface of the top substrate. In addition, each address electrode extends along a region formed between a central area of the discharge cell positioned at one side of the first barrier rib and the discharge cell positioned at the other side of the first barrier rib. The address electrodes include bus electrodes and transparent electrodes having predetermined width and length and being coupled with the bus electrodes in the discharge cells. At this time, the transparent electrodes are symmetrically aligned about the bus electrodes. The transparent electrodes have rectangular shapes when viewed in a plan view. In addition, bus electrodes include conductive metal electrodes and the transparent electrodes include ITO (indium tin oxide) electrodes. The top substrate is formed on a lower surface thereof with a top dielectric layer covering the address electrodes and the top dielectric layer is formed on a lower surface thereof with a top protective layer.

In addition, according to the present embodiments, the first and second electrodes are aligned in opposition to each other about discharge cells aligned in a direction crossing the address electrodes. The first and second electrodes may include conductive metal electrodes.

According to the present embodiments, the first dielectric layer has a width equal to or larger than a width of the second dielectric layer. The inner dielectric layer has a substantially right-angle triangular shape when viewed in a plan view, in which an oblique side of the inner dielectric layer faces an inner portion of the discharge cell. In addition, the oblique side of the inner dielectric layer facing the inner portion of the discharge cell has an arc shape having a predetermined curvature. The arc section of the inner dielectric layer is convex about the discharge cell. The inner dielectric layers are symmetrically aligned in the discharge cells about the address electrodes. The inner dielectric layers formed in the discharge cells are spaced apart from each other about the address electrodes by a predetermined distance equal to or larger than a width of the address electrode. In addition, the inner dielectric layers formed in the discharge cells are spaced apart from each other about the address electrodes by a predetermined distance equal to or larger than a width of the transparent electrode. The inner dielectric layers are integrally formed with first dielectric layers with a height identical to a height of the first dielectric layers.

In addition, a protective layer can be formed on a predetermined region of the dielectric layer, in which the predetermined region includes a lateral side of the first dielectric layer exposed to an inner portion of the discharge cell.

According to the present embodiments, the discharge cells positioned at one side of the first barrier ribs are offset from the discharge cells positioned at the other side of the first barrier rib by a distance corresponding to a half-length of the discharge cell. The first barrier rib has a width equal to or larger than a width of the second barrier rib. In addition, the barrier rib has a width equal to or larger than a width of the dielectric layer formed on the barrier rib.

The barrier ribs further include inner barrier ribs having shapes corresponding to shapes of inner dielectric layers when viewed in a plan view. At this time, lateral sides of the inner barrier ribs are aligned in line with lateral sides of the inner dielectric layers or protrude toward inner portions of the discharge cells.

In addition, the address electrodes are formed on an upper surface of the bottom substrate. The bottom substrate can be formed on the upper surface thereof with a bottom dielectric layer such that the address electrodes are covered with the bottom dielectric layer.

The plasma display panel further includes top barrier ribs aligned between the top substrate and the first and second electrodes with shape and height corresponding to those of the barrier ribs. At this time, the top barrier ribs include inner top barrier ribs having shapes corresponding to shapes of the inner barrier ribs.

In addition, the phosphor layer further includes a transmissive phosphor layer formed on lateral sides of the top barrier ribs and on the lower surface of the top substrate.

Another embodiment relates to a plasma display panel comprising:
a top substrate and a bottom substrate aligned in opposition to the top substrate;
a plurality of address electrodes aligned in parallel to each other and extending in one direction between the top substrate and the bottom substrate;
first and second electrodes extending in a direction crossing the address electrodes and alternately aligned substantially parallel to each other;
barrier ribs including first barrier ribs aligned substantially parallel to the first and second electrodes, and second barrier ribs aligned in a direction crossing the first barrier ribs in such a manner that discharge cells defined by the first and second barrier ribs are aligned at both sides of the first barrier ribs while being offset from each other about the first barrier ribs;
dielectric layers including first dielectric layers formed on outer surfaces of the first and second electrodes, second dielectric layers formed on upper surfaces of the second barrier ribs such that the second dielectric layers cross the first dielectric layers, and wherein the width of the first dielectric layer is larger than the width of the second dielectric layers; and
phosphor layers formed on an upper surface of the bottom substrate and on lateral sides of the barrier ribs in the discharge cells.

In some embodiments, the width of the first dielectric layer in intersection regions between the first and second dielectric layers is larger than that of the first dielectric layer in other regions.

In other embodiments, the first dielectric layer is protruding toward inner portions of the discharge cells from intersection regions between the first and second dielectric layers.

In still other embodiments, the dielectric layers comprises inner dielectric layers protruding toward inner portions of the discharge cells from intersection regions between the first and second dielectric layers.

### BRIEF DESCRIPTION OF THE DRAWINGS

The above and other features and advantages of the claimed embodiments will be more apparent from the following detailed description taken in conjunction with the accompanying drawings.

FIG. 1 is a perspective view illustrating a plasma display panel according to an exemplary embodiment;

FIG. 2 is a horizontal sectional view taken along line A-A shown in FIG. 1;

FIG. 3 is a horizontal sectional view taken along line B-B shown in FIG. 1;

FIG. 4 is a vertical sectional view taken along line C-C shown in FIG. 1;

FIG. 5 is a horizontal sectional view, which corresponds to FIG. 2, illustrating a plasma display panel according to another embodiment; and

FIG. 6 is a perspective view illustrating a plasma display panel according to still another embodiment.

### DETAILED DESCRIPTION OF THE PREFERRED EMBODIMENTS

Hereinafter, embodiments of a plasma display panel according to the present embodiments will be described with reference to the accompanying drawings.

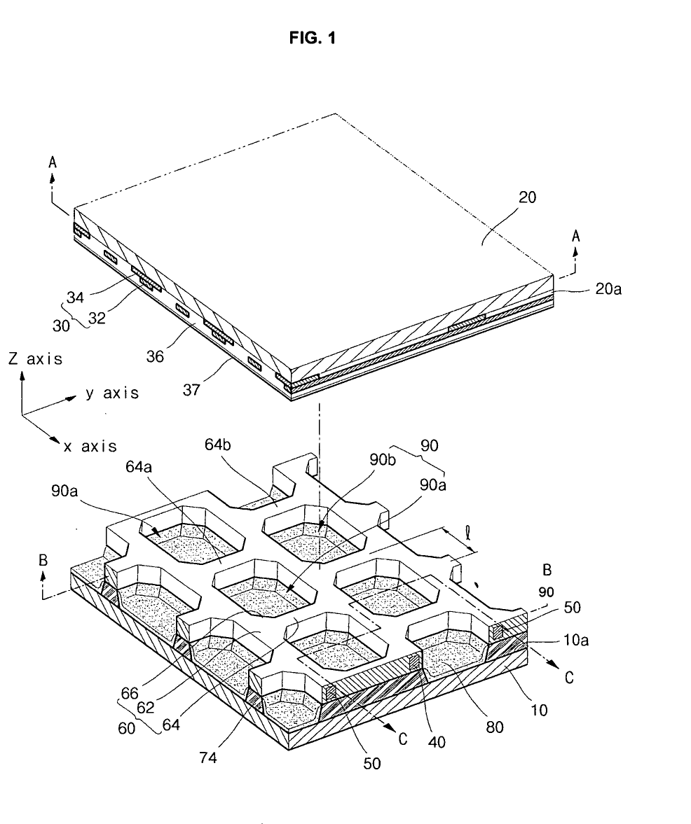

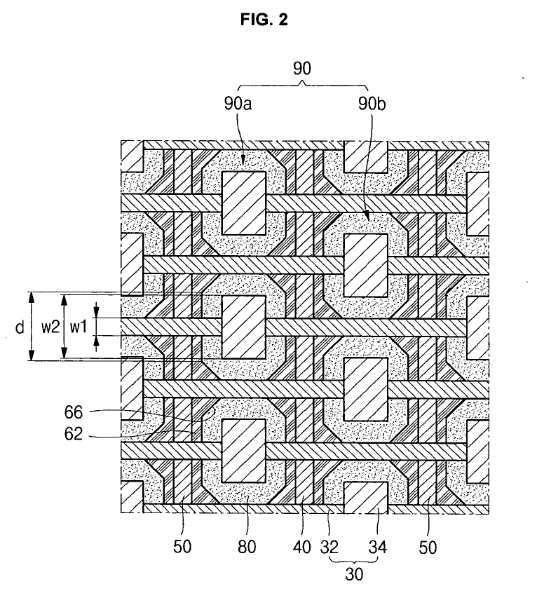

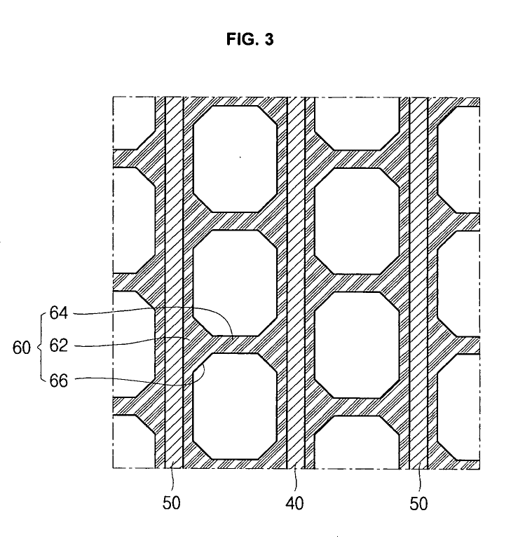

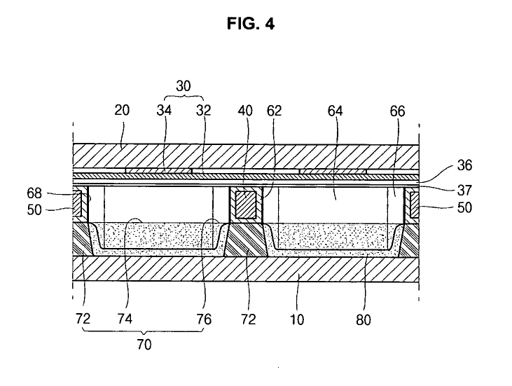

FIG. 1 is a perspective view illustrating a plasma display panel according to an exemplary embodiment, FIG. 2 is a horizontal sectional view taken along line A-A shown in FIG. 1, FIG. 3 is a horizontal sectional view taken along line B-B shown in FIG. 1, and FIG. 4 is a vertical sectional view taken along line C-C shown in FIG. 1.

Referring to FIGS. 1 to 4, the plasma display panel according to the exemplary embodiment includes a bottom substrate 10, a top substrate 20, address electrodes 30, first electrodes 40, second electrodes 50, a dielectric layer 60, barrier ribs 70, and a phosphor layer 80. In the following description, surfaces of elements facing the top substrate 20 in the +Z-axis direction in FIG. 1 are referred to as “upper surfaces” and surfaces of elements facing the bottom substrate 10 in the −Z-axis direction in FIG. 1 are referred to as “lower surfaces”.

The bottom substrate 10 can be made, for example, from glass and forms the plasma display panel together with the top substrate 20. The top substrate 20 is made from a transparent material, such as, for example, soda glass and is aligned in opposition to the bottom substrate 10 while forming a predetermined space therebetween. In addition, the address electrodes 30, the first electrodes 40, the second electrodes 50, and the barrier ribs 70 are positioned between the bottom substrate 10 and the top substrate 20. A plurality of discharge cells 90 are defined between the bottom substrate 10 and the top substrate 20 by means of the barrier ribs 70 and the phosphor layer 80 is formed on a predetermined area in the discharge cell 90.

The address electrodes 30 include bus electrodes 32 and transparent electrodes 34. Address discharge voltage is applied to the transparent electrodes 34 through the bus electrodes 32, so that the address electrodes 30 generate the address discharge together with the first electrodes 40.

The bus electrodes 32 is provided on the top substrate 20. Preferably, the bus electrode 32 is provided in a lower surface 20a of the top substrate 20 and extend in one direction (for instance, y-axis direction in FIG. 1) while being aligned in parallel to each other in the x-axis direction. Preferably, the bus electrodes 32 are aligned with an interval corresponding to a half-length of the discharge cell 90 in the x-axis direction. Accordingly, when the bus electrodes 32 extend in the y-axis direction through the discharge cells 90, which are alternately aligned about the first electrodes 40 (or second electrodes 50), the bus electrodes 32 pass through a center area 90a of the discharge cell 90 at one side of the first electrodes 40 and pass through a partition area 90b of the discharge cell 90 at the other side of the first electrodes 40.

The bus electrodes 32 have small widths in order to minimize interference with the visible ray when the visible ray passes through the top substrate 20 and are made from metals so as to reduce electric resistance. Preferably, the bus electrodes 32 are made from metallic materials having superior conductivity and low resistance, such as, for example, Ag, Al or Cu.

The transparent electrode 34 is made from a transparent material, such as, for example, ITO (indium tin oxide), having predetermined width and length. Preferably, the transparent electrode 34 has a rectangular upper surface. However, the transparent electrode 34 can be formed with an oval shape or a circular shape. The present embodiments are not so limited in shape of the transparent electrode 34. The transparent electrode 34 is electrically connected to the lower surface or the upper surface of the bus electrode 32. Preferably, the transparent electrodes 34 are symmetrically aligned about the bus electrodes 32. Accordingly, the transparent electrodes 34 are aligned in the center area of the discharge cell 90 and generate the address discharge together with the first electrodes 40.

The top substrate 20 can be formed at the lower surface thereof with a top dielectric layer 36 covering the whole area of the address electrodes 30. The top dielectric layer 36 electrically insulates the address electrodes 30 from each other while preventing the address electrodes 30 from being damaged during the discharge operation. In addition, a top protective layer 37, such as an MgO protective layer, can be formed on the lower surface of the top dielectric layer 36 in order to protect the address electrodes 30 and the top dielectric layer 36. The top protective layer 37 is made from MgO used for protecting the dielectric member in the plasma display panel. The top protective layer 37 not only prevents the electrodes from being damaged during the discharge operation, but also lowers the discharge voltage by discharging secondary electrons. The top protective layer 37 is mainly formed through sputtering or E-beam evaporation.

The first and second electrodes 40 and 50 are alternately positioned and extend in the x-axis direction while crossing the address electrodes 30 such that the discharge cell 90 can share the first and second electrodes 40 and 50. Therefore, the first and second electrodes 40 and 50 perform the discharge operation while facing each other about the discharge cell 90. Preferably, the first and second electrodes 40 and 50 are designed such that they have widths (horizontal lengths) smaller than heights (vertical lengths) thereof when the first and second electrodes 40 and 50 are sectioned vertically to the length direction thereof. Thus, the opposed discharge is generated over the large area of the first and second electrodes 40 and 50, so that a relatively great amount of visible ray can be generated. Such visible ray may collide with the phosphor layer 80 in the relatively large area of the discharge cell 90, thereby increasing quantity of visible ray emission. In addition, since the first electrodes 40 (hereinafter, referred to as scan electrodes generating the address discharge together with the address electrodes) generate the address discharge in a relatively large area together with the address electrodes 30 through the opposed discharge scheme, the address discharge operation can be efficiently performed. Although the first electrodes 40 serve as scan electrodes and the second electrodes 50 serve as sustain electrodes in the present embodiments, the above functions of the first and second electrodes 40 and 50 can be exchanged with each other.

Since the first and second electrodes 40 and 50 are aligned on the upper portion of the barrier ribs 70, it is not necessary to provide transparent properties to the first and second electrodes 40 and 50, so the first and second electrodes 40 and 50 are made from metallic materials having conductivity. Preferably, the first and second electrodes 40 and 50 are made from metallic materials having superior conductivity and low resistance, such as, for example, Ag, Al or Cu. In this case, the first and second electrodes 40 and 50 may represent the fast response speed for the discharge without causing signal distortion and can reduce power consumption during the sustain discharge operation. However, the present embodiments are not so limited in the possible materials for the first and second electrodes 40 and 50. Various metallic materials can be used for the first and second electrodes 40 and 50 if they have superior conductivity and low resistance.

Referring to FIG. 3, the dielectric layer 60 includes a first dielectric layer 62, a second dielectric layer 64 and an inner dielectric layer 66.

The first dielectric layer 62 is formed on the outer surfaces of the first and second electrodes 40 and 50 with a predetermined thickness. The first dielectric layer 62 prevents the electrodes from being damaged by charged particles colliding with the electrodes during the discharge operation. The first dielectric layer 62 is made from glass materials containing, for example, Pb, B, Si, Al, O or a mixture thereof. Preferably, the first dielectric layer 62 can include a filler such as ZrO₂, TiO₂, or A1₂O₃, and a pigment such as Cr, Cu, Co or Fe. However, the present embodiments are not so limited in the materials for the first dielectric layer 62 and the first dielectric layer 62 can be formed using various dielectric substances.

The second dielectric layer 64 is interposed between the first dielectric layers 62. The second dielectric layers 64 are aligned at left and right portions of the first electrodes 40 (or the second electrodes 50) while being offset from each other. Referring to FIG. 1, the second dielectric layers 64 consist of second dielectric layers 64a aligned in the vicinity of one side of the first electrodes 40 and second dielectric layers 64b aligned in the vicinity of the other side of the first electrodes 40 while being shifted from the second dielectric layers 64a by a distance (l) corresponding to the half-length of the discharge cell 90 in the x-axis direction. In addition, the second dielectric layer 64 has a predetermined width. Since electrodes, such as the first and second electrodes 40 and 50, are not formed in the second dielectric layer 64, the second dielectric layer 64 may have a width smaller than that of the first dielectric layer 62.

The second dielectric layer 64 is made from materials identical to those of the first dielectric layer 62. However, the present embodiments are not so limited in the materials for the second dielectric layer 64 and the second dielectric layer 64 can be formed using various dielectric substances.

The inner dielectric layer 66 has a predetermined shape and protrudes toward an inner portion of the discharge cell 90 from an intersection area between the first and second dielectric layers 62 and 64. In detail, the inner dielectric layer 66 is formed at the edge region of the discharge cell 90 where the first dielectric layer 62 meets the second dielectric layer 64, thereby allowing the discharge cell 90 to have an octagonal shape when viewed in a plan view. Preferably, the inner dielectric layer 66 has a substantially right-angle triangular shape when viewed in a plan view and adheres to the intersection part between the first and second dielectric layers 62 and 64 in such a manner that an oblique side of the inner dielectric layer 64 faces the inner portion of the discharge cell 90; however, the present embodiments are not limited thus.

The inner dielectric layers 66 can be symmetrically formed about the address electrodes 30 (or the second dielectric layers 64) provided above the inner dielectric layers 66. Referring to FIG. 2, an interval (d) between the inner dielectric layers 66 about the address electrodes 30 equals to or larger than the width (w₁) of the address electrode 30, preferably the interval (d) equals to or larger than the width (w₂) of the transparent electrode 34. Here, when the inner dielectric layer 66 has a triangular shape, the interval (d) refers to the distance in the x-axis direction between vertexes of two inner dielectric layers 66 adjacent to the address electrode 30. Therefore, since the inner dielectric layer 66 does not exert an influence upon the width of the first dielectric layer 62 formed on the outer surface of the first electrode 40 in the region where the address electrode 30 passes through, it is possible to minimize increase of the address voltage.

The inner dielectric layer 66 can be integrally formed with the first dielectric layer 62 or the second dielectric layer 64. Preferably, the inner dielectric layer 66 is integrally formed with the first dielectric layer 62 provided at an inner portion thereof with the first and second electrodes 40 and 50 performing the sustain discharge operation. In this case, the first dielectric layer is protruding toward inner portions of the discharge cells from intersection regions between the first and second dielectric layers. The width of the first dielectric layer 62 in intersection regions between the first and second dielectric layers is larger than that of the first dielectric layer 62 in other regions. If an interfacial surface is formed between the first dielectric layer 62 and the inner dielectric layer 66, the first and second electrodes 40 and 50 may be interrupted by the interfacial surface during the sustain discharge operation. For this reason, it is preferred to integrally form the inner dielectric layer 66 with the first dielectric layer 62. In this case, the discharge voltage can be effectively applied to the discharge cell without interfering with the interfacial surface.

Preferably, the inner dielectric layer 66 has a height identical to that of the first dielectric layer 62. Accordingly, the inner dielectric layer 66 may form a uniform discharge space in the height direction of the discharge cell 90.

In addition, referring to FIG. 4, a protective layer 68 can be formed on a predetermined region of the dielectric layer 60 including the lateral side of the first dielectric layer 62 exposed toward the inner portion of the discharge cell 90. The protective layer 68 can also be formed on the second dielectric layer 64 and on the lateral side of the inner dielectric layer 66. The protective layer 68 can be made from a material including MgO used for protecting the dielectric substance in the plasma display panel. The protective layer prevents the electrodes from being damaged during the discharge operation and emits secondary electrons so as to lower the discharge voltage.

The barrier ribs 70 include first barrier ribs 72 and second barrier ribs 74. In addition, the barrier ribs 70 can further include inner barrier ribs 76. The barrier ribs 70 define the discharge cells 90 between the top and bottom substrates 20 and 10. The barrier ribs 70 are made from, for example, glass substances including components, such as, for example, Pb, B, Si, Al or O. However, the present embodiments are not so limited in the materials for the barrier ribs 70. Preferably, the barrier rib 70 has a width larger than that of the dielectric layer 60 formed on the barrier rib 70 in such a manner that the phosphor layer formed on the lateral side of the barrier rib 70 can be prevented from being covered with the dielectric layer 60.
The first barrier ribs 72 are aligned on the upper surface of the bottom substrate 10 in parallel to each other while extending along one direction (for example, the x-axis direction in FIG. 1). In addition, the first barrier ribs 72 are positioned below the first and second electrodes 40 and 50 in parallel to the first and second electrodes 40 and 50. The first barrier ribs 72 are spaced apart from each other by an interval identical to the interval formed between the first and second electrodes 40 and 50.

Upper surfaces of the first barrier ribs 72 have widths larger than those of the first and second electrodes 40 and 50, in such a manner that only a minimum region of the phosphor layer 80 formed on the lateral side of the first barrier rib 72 is covered with the first and second electrodes 40 and 50. Preferably, upper surfaces of the first barrier ribs 72 have widths larger than those of the first dielectric layers 62 formed on the first and second electrodes 40 and 50, in such a manner that the phosphor layer 80 formed on the lateral side of the first barrier rib 72 can be prevented from being covered with the first dielectric layers 62. In addition, lower surfaces of the first barrier ribs 72 have widths larger than those of the upper surfaces of the first barrier ribs 72 in such a manner that the ultraviolet ray, which is generated between the first and second electrodes 40 and 50 during the sustain discharge operation, can frequently collide with the phosphor layer formed on the lateral side of the first barrier rib 72. In addition, similar to the first and second dielectric layers 62 and 64, the widths of the first barrier ribs 72 are larger than those of the second barrier ribs 74.

The second barrier ribs 74 are interposed between the first barrier ribs 72 vertically to the first barrier ribs 72 in such a manner that the discharge cells 90 defined by the first and second barrier cells 72 and 74 can be formed about the first barrier ribs 72 while being offset from each other. The second barrier ribs 74 are aligned on the lower surfaces of the second dielectric layers 64 in the same pattern as the second dielectric layers 64. That is, as mentioned above, the discharge cells 90 defined by the first and second barrier ribs 72 and 74 are offset from each other in the length direction of the first barrier rib 72 (for example, the x-axis direction in FIG. 1) by a distance corresponding to the half-length of the discharge cell 90.

Preferably, upper surfaces of the second barrier ribs 74 have widths larger than those of the second dielectric layers 64 in such a manner that the phosphor layer 80 formed on the lateral side of the second barrier rib 72 can be prevented from being covered with the second dielectric layers 64. In addition, lower surfaces of the second barrier ribs 74 have widths larger than those of the upper surfaces of the second barrier ribs 74 in such a manner that the ultraviolet ray, which is generated between the first and second electrodes 40 and 50 during the sustain discharge operation, can frequently collide with the phosphor layer formed on the lateral side of the second barrier rib 74.

The inner barrier rib 76 has a predetermined shape and protrudes toward an inner portion of the discharge cell 90 from an intersection area between the first and second barrier ribs 72 and 74. Preferably, the inner barrier ribs 76 have the shape substantially identical to that of the inner dielectric layer 66. For instance, if the inner dielectric layer 66 has a triangular shape, the inner barrier rib 76 also has the triangular shape. That is, the inner barrier rib 76 is formed at the edge region of the discharge cell 90 where the first barrier rib 72 meets the second barrier rib 74, thereby allowing the discharge cell 90 to have an octagonal shape when viewed in a plan view.

Preferably, lateral sides of the inner barrier ribs 76 facing the inner portion of the discharge cell 90 are aligned in line with lateral sides of the inner dielectric layers 66, or protrude toward the inner portion of the discharge cell 90 by a predetermined distance. Accordingly, the phosphor layer formed on the lateral side of the inner barrier rib 76 can be prevented from being covered with the inner dielectric layer 66.

The phosphor layer 80 is formed on a predetermined region, which is provided in the discharge cell 90 and includes at least the upper surface of the bottom substrate 10. In addition, the phosphor layer 80 can be formed on the lateral side of the barrier ribs 70 in the discharge cells 90. At this time, the barrier ribs 70 include at least one of first barrier ribs 72, second barrier ribs 74 and inner barrier ribs 76. The phosphor layer 80 is oriented toward the bottom substrate 10 on the basis of the discharge space in the discharge cell 90, so the phosphor layer 80 may serve as a reflective phosphor layer.

The phosphor layer 80 has components capable of generating visible rays by receiving ultraviolet rays. A red phosphor layer formed in a red emitting discharge cell includes fluorescent substances, such as Y(V,P)O₄:Eu, a green phosphor layer formed in a green emitting discharge cell includes fluorescent substances, such as Zn₂SiO₄:Mn, and a blue phosphor layer formed in a blue emitting discharge cell includes fluorescent substances, such as BAM:Eu. That is, the phosphor layer 80 is divided into the red, green and blue emitting phosphor layers provided in adjacent discharge cells 90, respectively. In addition, adjacent cells 90 having the red, green and blue emitting phosphor layers are combined with each other to form unit pixels for displaying color images.

The discharge cells 90 are defined by means of the bottom substrate 10, the barrier ribs 70 and the top substrate 20. As described above, the discharge cells 90 include first discharge cells 90a formed at one side of the first barrier ribs 72 and second discharge cells 90b formed at the other side of the first barrier ribs 72 while being offset from the first discharge cells 90a in the x-axis direction by a predetermined distance corresponding to the half-length of the discharge cell 90. Accordingly, the discharge cells 90 have the delta structure in which three adjacent cells are aligned in a triangular pattern to form one pixel. In addition, since the discharge cells 90 are offset from each other in the x-axis direction about the first electrodes 40, when the address discharge is performed between the address electrodes 40 passing through the first discharge cells 90a and the first electrodes 40, the address discharge may occur in the first discharge cells 90a, but the address discharge may not occur in second discharge cells 90b. Therefore, an ALIS (Alternate Lighting of Surfaces) driving scheme or an e-ALIS (Extended Alternate Lighting of Surfaces) driving scheme, which is typically employed in the opposed discharge type plasma display panel, is not needed in the plasma display panel according to the present embodiments. Thus, the plasma display panel according to the present embodiments can lengthen the reset period during the discharge operation, so that the plasma display panel can facilitate gray scale expression because the sustain discharge period is not relatively shortened.

The discharge cells 90 are filled with discharge gas (e.g., Xe, Ne, etc. or a mixture gas including Xe, Ne, etc) in order to generate the plasma discharge in the discharge cells 90. Accordingly, the plasma discharge is performed in the discharge cells 90 so that ultraviolet rays are generated. The ultraviolet rays collide with the phosphor layer 80, thereby emitting visible rays.

Hereinafter, a plasma display panel according to another embodiment will be described.

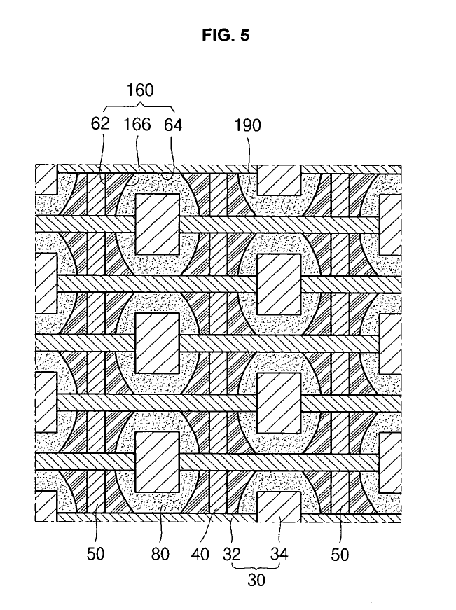

FIG. 5 is a horizontal sectional view partially illustrating the plasma display panel according to another embodiment. The plasma display panel according to another embodiment is substantially identical to the plasma display panel according to the exemplary embodiment shown in FIGS. 1 to 4, so the following description will be focused on different parts therebetween. In addition, the same reference numerals will be used to refer the same elements.

Referring to FIG. 5, the plasma display panel according to another embodiment includes dielectric layers 160 consisting of first dielectric layers 62, second dielectric layers 64, and inner dielectric layers 166. When viewed in a plan view, the inner dielectric layer 166 has a substantially right-angle triangular shape in which an oblique side thereof is formed in an arc shape having a predetermined curvature. Preferably, the oblique side of the inner dielectric layer 166 is convex about the discharge cell 190. Therefore, since one lateral side of the inner dielectric layer 166 is curved with a predetermined curvature, a relatively large discharge space can be formed in the discharge cell 190.

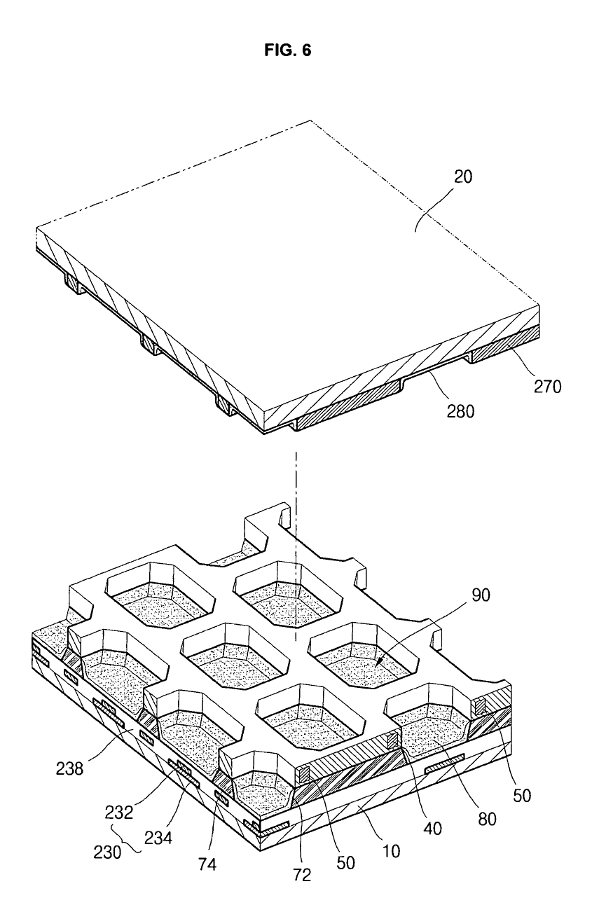

Hereinafter, a plasma display panel according to still another embodiment will be described. FIG. 6 is an exploded perspective view illustrating the plasma display panel according to still another embodiment. The plasma display panel according to still another embodiment is substantially identical to the plasma display panel according to the exemplary embodiment shown in FIGS. 1 to 4, so the following description will be focused on different parts therebetween. In addition, the same reference numerals will be used to refer the same elements.

Referring to FIG. 6, the plasma display panel according to still another embodiment includes address electrodes 230 formed on the upper surface of the bottom substrate 10. In addition, the plasma display panel can further include a top barrier rib 270 and a transmissive phosphor layer, which are provided on the lower surface of the top substrate 20.

The address electrodes 230 are aligned on the upper surface of the bottom substrate 10 while extending in one direction (for example, the y-axis direction in FIG. 1) in parallel to each other in the x-axis direction. In addition, the address electrodes 230 include bus electrodes 232 and transparent electrodes 234. The address discharge voltage is applied to the transparent electrodes 234 through the bus electrodes 232 so that the address electrodes 230 generate the address discharge together with the first electrodes 50. In addition, a bottom dielectric layer 238 is formed on the upper surface of the bottom substrate 10 such that the address electrodes 230 can be covered with the bottom dielectric layer 238. Referring variously to FIGS. 1-6, although the address electrodes 230 are formed on the upper surface of the bottom substrate 10 different from the address electrodes 30 formed on the upper surface of the top substrate 20, the address electrodes 230 are substantially identical to the address electrodes 30 shown in FIG. 1 in view of shapes and materials, so the detailed description thereof will be omitted below.

The top barrier ribs 270 have the shape and height corresponding to those of the first and second barrier ribs 72 and 74(referring FIG. 4). In addition, the top barrier ribs 270 can further include inner top barrier ribs (referring FIG. 4) having the shape corresponding to that of the inner barrier ribs 76(referring FIG. 4). The top barrier ribs 270 form the discharge cells 90 at the lower surface of the top substrate 20 together with the barrier ribs 70(referring FIG. 4).

The transmissive phosphor layer 280 is aligned on a lower surface 20a of the top substrate 20 in the discharge cell 90. Preferably, the transmissive phosphor layer 280 is formed on a predetermined region including the lateral side of the top barrier ribs 270 with a predetermined thickness. The transmissive phosphor layer 280 absorbs the vacuum ultraviolet rays such that visible rays can be transmitted onto the upper surface of the bottom substrate 10. The transmissive phosphor layer 280 is thinner than the phosphor layer 80 formed on the upper surface of the bottom substrate 10. That is, since transmittance of visible rays in the transmissive phosphor layer 280 is substantially proportional to the thickness of the phosphor layer, the transmissive phosphor layer 280 preferably has a thickness thinner than that of the phosphor layer 80 in order to improve transmittance of the visible rays transmitted onto the top substrate 20. Accordingly, the transmissive phosphor layer 280 can transmit the visible rays through the top substrate 20 without loss when the visible rays are generated from both the transmissive phosphor layer 280 and the phosphor layer 80.

Hereinafter, the discharge operation of the plasma display panel according to the present embodiments will be described.

In the plasma display panel according to the present embodiments, the discharge operation is carried out in the order of reset discharge, address discharge and sustain discharge processes. The following description will be focused on the address discharge and sustain discharge processes.

The address discharge is performed as the address voltage is applied between the address electrodes 30, which are provided on the lower surface 20a of the top substrate 20, and the first electrodes 40 serving as scan electrodes. In more detail, the address discharge is performed between the transparent electrodes 34 of the address electrodes 30 and the first electrodes 40, thereby addressing the discharge cells 90 where the sustain discharge is performed. At this time, since the distance between the transparent electrode 34 and the first electrode 40 is relatively short, it is possible to perform the address discharge operation with a small address voltage. In addition, since the discharge cells 90 are aligned in the delta structure, one discharge cell 90 can be addressed as the address voltage is applied to one address electrode 30 and first electrode 40.

Then, the sustain discharge is performed as a predetermined sustain voltage is applied to the first and second electrodes 40 and 50, which are aligned in opposition to each other about the discharge cells 90. Since the sustain discharge is carried out between the first and second electrodes 40 and 50 through the opposed discharge scheme in a state in which the first and second electrodes 40 and 50 are aligned in opposition to each other about the discharge cells 90 while forming a log gap therebetween, the discharge efficiency and discharge uniformity can be improved. The ultraviolet rays generated during the sustain discharge operation may collide with the phosphor layer 80 formed on the upper surface of the bottom substrate 10, thereby emitting the visible rays. At this time, since the phosphor layer 80 is exposed toward both the top substrate 20 and the discharge space formed at the center between the first and second electrodes 40 and 50, the ultraviolet rays can collide with the whole area of the phosphor layer 80, so that the efficiency of visible ray emission can be improved. In addition, since the phosphor layer 80 can reflect majority of the visible rays toward the top substrate 20, the luminous efficiency can be improved.

As described above, the plasma display panel according to the present embodiments includes discharge cells having the delta structure. Thus, different from the convention opposed discharge type plasma display panel, the plasma display panel of the present embodiments makes it possible to address only one discharge cell 90 during the address discharge process. Therefore, the present embodiments are not limited to the ALIS driving scheme or the e-ALIS driving scheme, which is typically employed in the opposed discharge type plasma display panel, so that the present embodiments can advantageously achieve gray scale expression.

According to the plasma display panel of the present embodiments, the width of the central portion of the dielectric layer having the electrodes generating the sustain discharge in the discharge cell is smaller than the width of the peripheral portion of the dielectric layer, so that electron loss can be minimized at the peripheral portion of the dielectric layer, thereby improving the luminous efficiency of the plasma display panel.

In addition, according to the present embodiments, the dielectric layer provided at an inner portion thereof with the scan electrodes and sustain electrodes may not hide the phosphor layer even if the scan electrodes and sustain electrodes are aligned closer to the top substrate than that of the phosphor layer, so that the ultraviolet rays may easily reach the phosphor layer and visible rays generated from the phosphor layer can effectively reach the top substrate, thereby improving the luminous efficiency of the plasma display panel.

Furthermore, the plasma display panel according to the present embodiments includes the discharge cells having the delta structure. Thus, different from the convention opposed discharge type plasma display panel, the plasma display panel makes it possible to address only one discharge cell during the address discharge process. Therefore, the present are not limited to the ALIS driving scheme or the e-ALIS driving scheme, so that the present embodiments can advantageously achieve gray scale expression.

Although some preferred embodiments have been described for illustrative purposes, those skilled in the art will appreciate that various modifications, additions and substitutions are possible, without departing from the scope and spirit of the present embodiments as disclosed in the accompanying claims.

What is claimed is:

1. A plasma display panel comprising:
a top substrate and a bottom substrate aligned in opposition to the top substrate;
a plurality of address electrodes aligned in parallel to each other and extending in one direction between the top substrate and the bottom substrate;
first and second electrodes extending in a direction crossing the address electrodes and alternately aligned substantially parallel to each other;
barrier ribs including first barrier ribs aligned substantially parallel to the first and second electrodes, and second barrier ribs aligned in a direction crossing the first barrier ribs in such a manner that discharge cells defined by the first and second barrier ribs are aligned at both sides of the first barrier ribs while being offset from each other about the first barrier ribs;
dielectric layers including first dielectric layers formed on outer surfaces of the first and second electrodes, second dielectric layers formed on upper surfaces of the second barrier ribs such that the second dielectric layers cross the first dielectric layers, and inner dielectric layers protruding toward inner portions of the discharge cells from intersection regions between the first and second dielectric layers; and
phosphor layers formed on an upper surface of the bottom substrate and on lateral sides of the barrier ribs in the discharge cells.

2. The plasma display panel as claimed in claim 1, wherein the address electrodes are formed on the top substrate.

3. The plasma display panel as claimed in claim 1, wherein each address electrode extends along a region formed between a central area of the discharge cell positioned at one side of the first barrier rib and an area of the discharge cell positioned at the other side of the first barrier rib.

4. The plasma display panel as claimed in claim 1, wherein the address electrodes include bus electrodes and transparent electrodes having predetermined width and length and being coupled with the bus electrodes in the discharge cells.

5. The plasma display panel as claimed in claim 4, wherein the transparent electrodes are symmetrically aligned about the bus electrodes.

6. The plasma display panel as claimed in claim 4, wherein the transparent electrodes have rectangular shapes when viewed in a plan view.

7. The plasma display panel as claimed in claim 4, wherein the bus electrodes include conductive metal electrodes.

8. The plasma display panel as claimed in claim 4, wherein the transparent electrodes include ITO (indium tin oxide) electrodes.

9. The plasma display panel as claimed in claim 1, wherein the top substrate is formed on a lower surface thereof with a top dielectric layer covering the address electrodes.

10. The plasma display panel as claimed in claim 9, wherein the top dielectric layer is formed on a lower surface thereof with a top protective layer.

11. The plasma display panel as claimed in claim 1, wherein the first and second electrodes are aligned in opposition to each other about discharge cells aligned in a direction crossing the address electrodes.

12. The plasma display panel as claimed in claim 1, wherein the first and second electrodes include conductive metal electrodes.

13. The plasma display panel as claimed in claim 1, wherein the first dielectric layer has a width equal to or larger than the width of the second dielectric layer.

14. The plasma display panel as claimed in claim 1, wherein the inner dielectric layer has a substantially right-angle triangular shape when viewed in a plan view, in which an oblique side of the inner dielectric layer faces an inner portion of the discharge cell.

15. The plasma display panel as claimed in claim 14, wherein the oblique side of the inner dielectric layer facing the inner portion of the discharge cell has an arc shape having a predetermined curvature.

16. The plasma display panel as claimed in claim 15, wherein the arc section of the inner dielectric layer is convex about the discharge cell.

17. The plasma display panel as claimed in claim 5, wherein the inner dielectric layers are symmetrically aligned in the discharge cells about the address electrodes.

18. The plasma display panel as claimed in claim 17, wherein the inner dielectric layers formed in the discharge cells are spaced apart from each other about the address electrodes by a predetermined distance equal to or larger than a width of the address electrode.

19. The plasma display panel as claimed in claim 17, wherein the inner dielectric layers formed in the discharge cells are spaced apart from each other about the address electrodes by a predetermined distance equal to or larger than a width of the transparent electrode.

20. The plasma display panel as claimed in claim 1, wherein the inner dielectric layers are integrally formed with first dielectric layers.

21. The plasma display panel as claimed in claim 1, wherein the inner dielectric layers have a height identical to a height of the first dielectric layers.

22. The plasma display panel as claimed in claim 1, wherein a protective layer is formed on a predetermined region of the dielectric layer, in which the predetermined region includes a lateral side of the first dielectric layer exposed to an inner portion of the discharge cell.

23. The plasma display panel as claimed in claim 1, wherein the discharge cells positioned at one side of the first barrier ribs are offset from the discharge cells positioned at the other side of the first barrier rib by a distance corresponding to a half-length of the discharge cell.

24. The plasma display panel as claimed in claim 1, wherein the first barrier rib has a width equal to or larger than a width of the second barrier rib.

25. The plasma display panel as claimed in claim 24, wherein the barrier rib has a width equal to or larger than a width of the dielectric layer formed on the barrier rib.

26. The plasma display panel as claimed in claim 1, wherein the barrier ribs further include inner barrier ribs having shapes corresponding to shapes of inner dielectric layers when viewed in a plan view.

27. The plasma display panel as claimed in claim 26, wherein lateral sides of the inner barrier ribs are aligned in line with lateral sides of the inner dielectric layers or protrude toward inner portions of the discharge cells.

28. The plasma display panel as claimed in claim 1, wherein the address electrodes are formed on an upper surface of the bottom substrate.

29. The plasma display panel as claimed in claim 28, wherein the bottom substrate is formed on the upper surface thereof with a bottom dielectric layer such that the address electrodes are covered with the bottom dielectric layer.

30. The plasma display panel as claimed in claim 28, further comprising top barrier ribs aligned between the top substrate and the first and second electrodes with shape and height corresponding to those of the barrier ribs.

31. The plasma display panel as claimed in claim 28, wherein the top barrier ribs include inner top barrier ribs having shapes corresponding to shapes of the inner barrier ribs.

32. The plasma display panel as claimed in claim 30, wherein the phosphor layer further includes a transmissive phosphor layer formed on lateral sides of the top barrier ribs and on the lower surface of the top substrate.

33. The plasma display panel as claimed in claim 31, wherein the phosphor layer further includes a transmissive phosphor layer formed on lateral sides of the top barrier ribs and on the lower surface of the top substrate.

34. A plasma display panel comprising:
a top substrate and a bottom substrate aligned in opposition to the top substrate;
a plurality of address electrodes aligned in parallel to each other and extending in one direction between the top substrate and the bottom substrate;
first and second electrodes extending in a direction crossing the address electrodes and alternately aligned substantially parallel to each other;
barrier ribs including first barrier ribs aligned substantially parallel to the first and second electrodes, and second barrier ribs aligned in a direction crossing the first barrier ribs in such a manner that discharge cells defined by the first and second barrier ribs are aligned at both sides of the first barrier ribs while being offset from each other about the first barrier ribs;
dielectric layers including first dielectric layers formed on outer surfaces of the first and second electrodes, second dielectric layers formed on upper surfaces of the second barrier ribs such that the second dielectric layers cross the first dielectric layers, and wherein the width of the first dielectric layer is larger than the width of the second dielectric layers; and
phosphor layers formed on an upper surface of the bottom substrate and on lateral sides of the barrier ribs in the discharge cells.

35. The plasma display panel as claimed in claim 34, wherein the width of the first dielectric layer in intersection regions between the first and second dielectric layers is larger than that of the first dielectric layer in other regions.

36. The plasma display panel as claimed in claim 34, wherein the first dielectric layer is protruding toward inner portions of the discharge cells from intersection regions between the first and second dielectric layers.

37. The plasma display panel as claimed in claim 34, wherein dielectric layers comprises inner dielectric layers protruding toward inner portions of the discharge cells from intersection regions between the first and second dielectric layers.
